(19) United States
(12) Patent Application Publication
(10) Pub. No.: US 2015/0178902 A1
(43) Pub. Date: Jun. 25, 2015

(54) IMAGE PROCESSING APPARATUS AND IMAGE PROCESSING METHOD FOR REMOVING RAIN STREAKS FROM IMAGE DATA

(71) Applicants: Hyundai Motor Company, Seoul (KR); Kia Motors Corporation, Seoul (KR); Inha-Industry Partnership Institute, Incheon (KR)

(72) Inventors: Won Seok Lee, Seongnam (KR); Byung Cheol Song, Seoul (KR); Hak Gu Kim, Anyang (KR); Seung Ji Seo, Seoul (KR)

(21) Appl. No.: 14/301,811

(22) Filed: Jun. 11, 2014

(30) Foreign Application Priority Data
Dec. 19, 2013 (KR) 10-2013-0159192

(51) Int. Cl. G06T 5/00; B60S 1/08

(52) U.S. Cl. CPC G06T 5/005; B60S 1/0818; G06T 2207/30252; G06T 2207/30192

(57) ABSTRACT

An image processing apparatus and method for removing rain streaks from image data are provided. The apparatus includes at least one imaging device that is configured to acquire image data and a controller that is configured to detect and remove a rain streak in the image data. In addition, the controller is configured to restore image data at an area where the removed rain streak was to be output.

### CROSS-REFERENCE TO RELATED APPLICATION

This application is based on and claims priority from Korean Patent Application No. 10-2013-0159192, filed on Dec. 19, 2013 in the Korean Intellectual Property Office, the disclosure of which is incorporated herein in its entirety by reference.

### BACKGROUND

1. Field of the Invention

The present invention relates to an image processing apparatus and an image processing method for removing rain streaks from image data, and more particularly, to an image processing apparatus and an image processing method for removing rain streaks from image data, in which a rain drop is detected and removed in image data acquired by capturing a rainfall scene and image data of a pixel where a rain drop is removed is restored.

2. Description of the Prior Art

In an outside video monitoring system, a weather condition is one of different factors that may deteriorate the quality of image data and in turn the performance of the system. Existing image data processing algorithms operate under the assumption that input image data is of sufficient quality. Therefore, to improve the performance of the system, preprocessing is required to improve the quality of exterior image data.

### SUMMARY

Accordingly, the present invention provides an image processing apparatus and an image processing method for removing rain streaks from image data, in which a rain drop is detected and removed in image data acquired by an imaging device when rain is detected and image data of a pixel when a rain drop is detected is restored to be output.

In one aspect of the present invention, an image processing apparatus for removing rain streaks from image data may include: at least one imaging device (e.g., a camera, video camera, etc.) configured to acquire image data; and a controller configured to detect and remove a rain streak in the image data and restore image data at an area when the removed rain streak was to output it.

The controller may be configured to detect brightness of a pixel in the image data and detect brightness of pixels around the pixel (e.g., neighboring pixels). The controller may be configured to select the brightest pixel as a candidate area for a rain streak from among the detected pixels and connect pixels selected as candidate areas for a rain streak to create a single rain streak. The controller may also be configured to measure an angle and a length of the single rain streak to select final candidate areas for a rain streak and expand a rain streak area into pixels around the selected final candidate areas. The controller may be configured to delete data of pixels that corresponds to the rain streak areas.

Furthermore, the controller may be configured to create an image block with respect to pixels from which the data is removed and extract at least one previous frame to a current frame to extract a candidate block from the previous frame. The controller may be configured to detect a similarity between the image block and the candidate block to restore the pixels from which data is removed with the candidate block. The controller may also be configured to automatically operate a wiper of a vehicle when a rain streak is detected in the image data. The controller may be configured to automatically turn on a lamp including a headlight and a taillight of a vehicle when a rain streak is detected in the image data. The image processing apparatus may further include: a sensor configured to sense rainfall.

In another aspect of the present invention, an image processing method for removing a rain streak in image data may include: acquiring, by a controller, image data; detecting, by the controller, a rain streak in the acquired image data; removing, by the controller, the detected rain streak; restoring, by the controller, image data at a area where the removed rain streak was to output it; and outputting, by the controller, the restored image data.

The detection of a rain streak may include: detecting a brightness of a pixel in the image data; detecting a brightness of pixels around the pixel (e.g., neighboring pixels); selecting the brightest pixel as a candidate area for a rain streak; connecting pixels selected as candidate areas for a rain streak to create a single rain streak; measuring an angle and a length of the single rain streak; and setting final candidate areas for the rain streak to expand a rain streak area into pixels around the selected final candidate areas. The removal of the detected rain streak may include deleting data of pixels that corresponds to the rain streak areas. The restoration of the image data may include: creating an image block with respect to the pixel from which data is removed; extracting at least one previous frame to a current frame; extracting a candidate block from the previous frame; and detecting a similarity between the image block and the candidate block to restore the pixel from which data is removed with the candidate block.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary block diagram showing constituent elements of an image processing apparatus according to an exemplary embodiment of the present invention;

FIG. 2 is an exemplary flow chart for illustrating an image processing method according to an exemplary embodiment of the present invention;

FIG. 3 is an exemplary flow chart for illustrating a method for detecting rain streaks from image data according to an exemplary embodiment of the present invention in detail;

FIGS. 4A to 4C are exemplary screen views of detecting rain streaks from image data according to an exemplary embodiment of the present invention; and

FIG. 5 is an exemplary flow chart for illustrating a method for restoring image data from which rain streaks are removed according to an exemplary embodiment of the present invention in detail.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, exemplary embodiments of the present invention will be described in detail with reference to the accompanying drawings. In the following descriptions, features that are well known in the art and are not directly related to the present invention may not be described. This is to clarify the gist of the present invention clearly without obscuring it by way of omitting unnecessary descriptions.

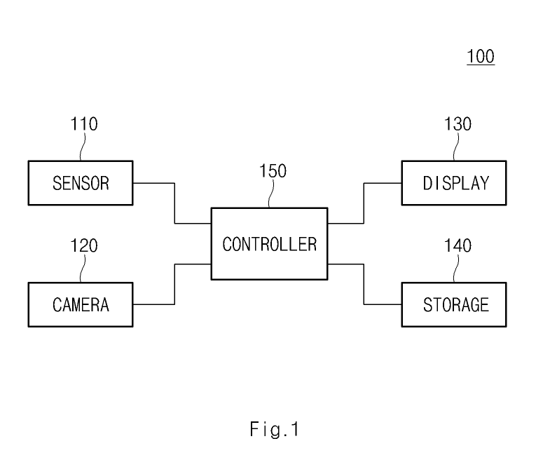

FIG. 1 is an exemplary block diagram showing constituent elements of an image processing apparatus according to an exemplary embodiment of the present invention. Referring to FIG. 1, the image processing apparatus may include a sensor 110, an imaging device 120, a display 140, storage 140, and a controller 130.

The sensor 110 may be disposed extraneous (e.g., on an exterior of) a vehicle to sense (e.g., detect) a rain condition outside the vehicle. Accordingly, the sensor 110 may be implemented as a rain sensor. The sensor 110 may be configured to acquire sensing information regarding weather in real-time and provide the sensing information to the controller 150. The imaging device 120 (e.g., a camera, a video camera, or the like) may be configured to acquire or capture image data extraneous to the vehicle under the operation of the controller 150. A plurality of imaging devices 120 may be disposed at a front and rear of the vehicle. The display 130 may be configured to display a screen that corresponds to operations performed in the image processing apparatus 100. In particular, the display 130, under the operation of the controller 150, may be configured to display image data acquired by the imaging device 120 and display image data from which rain streaks are removed in the event of rain. Therefore, the display 130 may be a liquid crystal display (LCD) or the like and may also operate as an input device when the display is a touch screen. The storage 140 may be configured to store various programs for operations performed in the image processing apparatus 100. In particular, the display 130, under the operation of the controller 150, may be configured to display image data acquired by the imaging device 120 and display image data from which rain streaks are removed in the event of rain.

The controller 150 may be configured to detect rain streaks in the image data acquired by the imaging device 120, remove the rains streaks from the image data, and restore image data at areas where the removed rain streaks were to output the image data. More specifically, the controller 150 may be configured to determine a rain condition outside based on the sensing information provided from the sensor 110 and invoke the image processing algorithm stored in the storage 140 in response to determining the rain condition. The controller 150 may be configured to analyze the image data acquired by the imaging device 120 and detect rain streaks in the image data using the image processing algorithm. The controller 150 may be configured to select a pixel from the image data acquired by the imaging device 120 and detect a brightness of the selected pixel. Then, the controller 150 may be configured to detect the brightness of pixels around the selected pixel (e.g., neighboring pixels).

Furthermore, the controller 150 may be configured to detect three pixels at the right side and three pixels at the left side of the selected pixel, for example (e.g., may detect pixels to either side of the selected pixel). The controller 150 may be configured to choose the brightest pixel from among the seven pixels to select the brightest pixel as a candidate area for a rain streak. When a difference between the maximum value and the minimum value of the brightness is equal to or greater than a threshold value, the controller 150 may be configured to determine that the pixels correspond to a border line in the image data and may then exclude those pixels from candidate areas for a rain streak.

Additionally, the controller 150 may be configured to detect the brightness of every pixel in the image data in the above-described manner, and connect pixels selected as candidate areas for a rain streak to create a rain streak. The controller 150 may be configured to measure the angle and length of a single rain streak to select final candidate areas for a rain streak. In particular, when the length of the single rain streak is less than a predetermined length, the controller 150 may be configured to exclude the single rain streak from the final candidate areas. The controller 150 may be configured to detect the average angle of the candidate areas for a rain streak and exclude a rain streak from the final candidate areas which has an angle deviating from the detected average angle by more than a threshold value. In addition, the controller 150 may be configured to expand a rain streak area into pixels around the selected final candidate areas. Since the brightness of the rain streak areas may change according to the Gaussian distribution, it may be desirable to expand the rain streak area into adjacent pixel areas according to the Gaussian distribution.

Moreover, the controller 150 may be configured to delete data of the pixels that corresponds to the rain streak areas selected as the final candidate areas. Then, the controller 150 may be configured to restore image data of the pixel in which data has been deleted. Accordingly, when restored image data is displayed on the display 130, the controller 150 may be configured to extract image data from the previous frame to the frame in which the pixel is deleted to use the image data in restoring image data so that a driver does not feel sense of difference. Specifically, the controller 150 may be configured to create an image block in the frame of the image data including the pixels in which data has been deleted. The controller 150 may be configured to extract three to five previous frames to the frame in which the image block is created. The controller 150 may be configured to match (e.g., correlate) blocks from the frame in which the image block is created with blocks from the previous frames to create candidate blocks from the previous frames. Therefore, when it rains heavily, rain streaks may be detected at similar positions of image data over several frames. Accordingly, the controller 150 may be configured to create blocks in the previous frames at similar positions to positions where image blocks are created.

The controller 150 may further be configured to determine the ranks of the candidate blocks to cause a block having a smaller sum of difference (SAD) with the image block to have a higher rank. Since an optimal motion vector derived using block matching and an optimal block that corresponds thereto may not provide sufficient amount of available information, the image data may not be accurately restored. Therefore, the controller 150 may be configured to determine several candidate blocks.

The controller 150 may be configured to determine similarity between the image block and the candidate blocks. The controller 150 may also be configured to determine a candidate block as a reliable candidate block when the similarity is less than a threshold value and determine a candidate block as an unreliable candidate block when the similarity is greater than a threshold value. The controller 150 may be configured to use reliable candidate blocks to restore image data of an area when the removed rain streak was in the image block. The controller 150 may then be configured to calculate weights of candidate blocks to restore data of pixels from which rains streaks are removed to cause the brightness to correspond to weights. In addition, the controller 150 may be configured to automatically operate a vehicle wiper or automatically turn on lamps such as a headlight or a taillight of the vehicle when rain streaks are detected in the image data, thereby improve driver's convenience while driving. When this operation occurs, the controller 150 may be configured to adjust the operation speed of the wiper or the brightness of the lamps based on the amount of detected rain streaks.

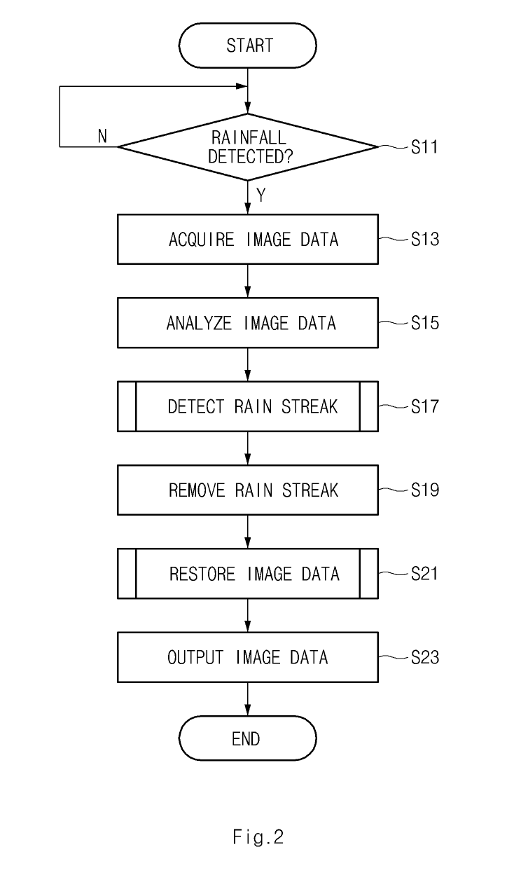

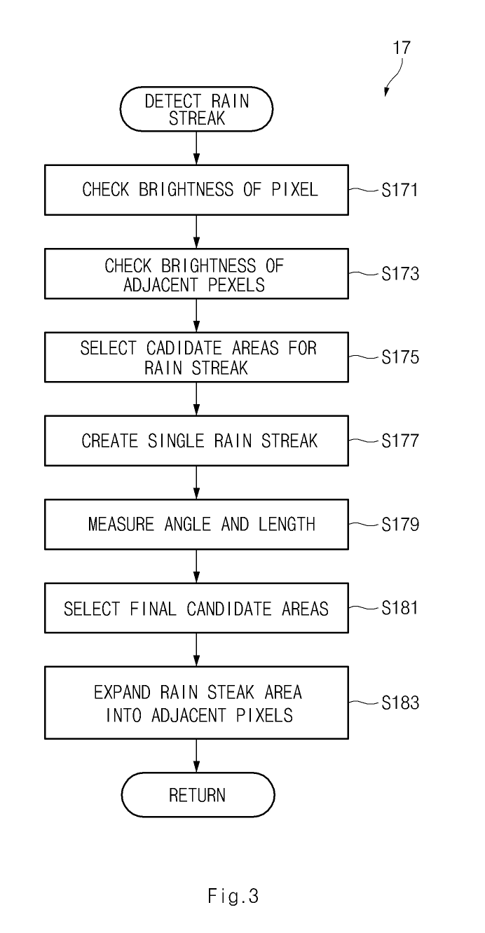

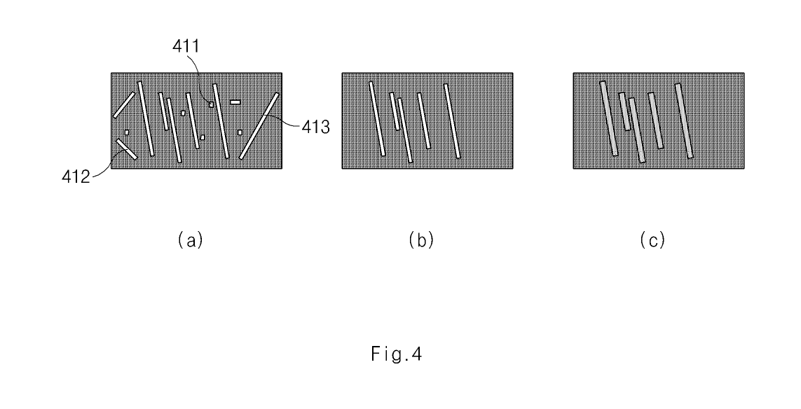

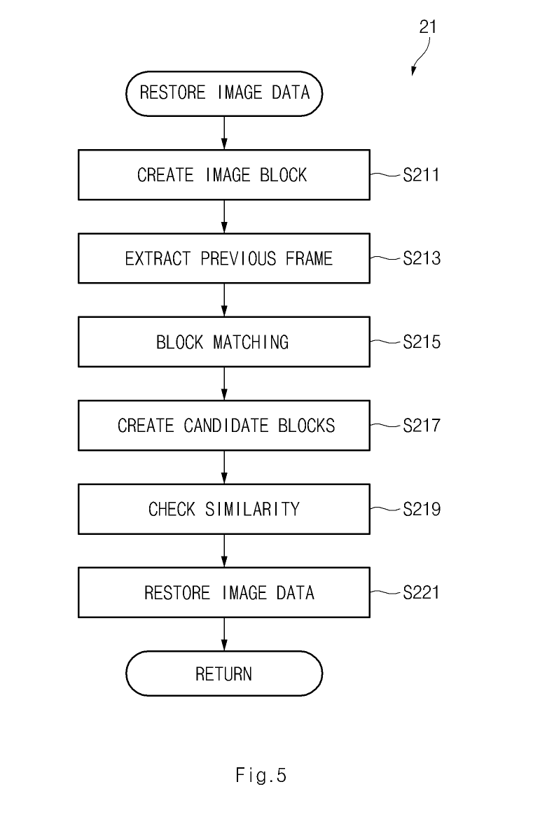

FIG. 2 is an exemplary flow chart for illustrating an image processing method according to an exemplary embodiment of the present invention. FIG. 3 is an exemplary flow chart for illustrating a method for detecting rain streaks from image data according to an exemplary embodiment of the present invention in detail. FIGS. 4A to 4C are exemplary screen views of an example of detecting rain streaks from image data according to an exemplary embodiment of the present invention. FIG. 5 is an exemplary flow chart for illustrating a method for restoring image data from which rain streaks are removed according to an exemplary embodiment of the present invention in detail.

Referring to FIGS. 1 to 5, in step S11, the controller 150 may be configured to determine a rain condition a vehicle based on sensing information from the sensor 110. In step S13, in response to determining the rain condition, the controller 150 may be configured to receive image data acquired by the imaging device 120. In step S15, the controller 150 may be configured to analyze the received image data. Accordingly, the controller 150 may be configured to invoke an image processing algorithm stored in the storage 140. In step S17, the controller 150 may be configured to detect rain streaks from the image data. Although a rain condition may be determined outside a vehicle based on the sensing information from the sensor 110 in this exemplary embodiment, the present invention is not limited thereto and the rain condition may be determined based on a driver's input or analysis results of the image data acquired by the imaging device 120.

Furthermore, in step S171 of FIG. 3, the controller 150 may be configured to select a pixel from the image data to detect the brightness of the selected pixel. In step S173, the controller 150 may be configured to detect the brightness of pixels around the selected pixel (e.g., neighboring pixels). In particular, the controller 150 may be configured to detect three pixels at to the right side and three pixels at to the left side of the selected pixel, for example. In step S175, the controller 150 may be configured to choose the brightest pixel from among the seven pixels to select the brightest pixel as a candidate area for a rain streak. When a difference between the maximum value and the minimum value of the brightness of the pixels is equal to or greater than a threshold value, the controller 150 may be configured to determine that the pixels correspond to a border line in the image data so that the controller 150 may be configured to exclude the pixel from candidate areas for a rain streak.

Subsequently, in step S177, the controller 150 may be configured to connect pixels selected as candidate areas for a rain streak to create a single rain streak. In step S179, the controller 150 may be configured to measure the angle and length of the created single rain streak. Then, in step S181, the controller 150 may be configured to select final candidate areas for a rain streak. This may be represented as shown in FIGS. 4A and 4B. When the length of a created single rain streak 411 in FIG. 4A is less than a predetermined length, the controller 150 may be configured to exclude the rain streak from candidate areas for a rain streak. Further, the controller 150 may be configured to detect the average angle of the candidate areas for a rain streak and exclude rain streaks 412 and 413 in FIG. 4A from candidate areas for a rain streak which have angles deviating from the checked average angle by more than a threshold value.

Additionally, in step S183, the controller 150 may be configured to expand the rain streak area into pixels around the selected final candidate areas in step S181. The controller 150 may be configured to expand rain streak areas into substantially even adjacent pixels according to the Gaussian distribution based on the fact that the bright change in the substantial center of the rain streak areas finally selected in step S181 occurs according to the Gaussian distribution. This may be represented as shown in FIG. 4C. Referring again to FIG. 2, in step S19, the controller 150 may be configured to remove the confirmed rain streaks from the image data. Specifically, the controller 150 may be configured to delete data of pixels that corresponds to the expanded rain streak areas in step S183 of FIG. 3.

In step S21, the controller 150 may be configured to restore image data of the pixel in which data has been deleted in step S19. Specifically, in step S211 of FIG. 5, the controller 150 may be configured to create an image block in the frame of the image data including the pixels in which data has been deleted. Subsequently, the process proceeds to step S213, in which the controller 150 may be configured to extract a previous frame to the frame in which the image block is created. The controller 150 may be configured to extract three to five previous frames to the frame in which the image block is created. In step S215, the controller 150 may be configured to perform block matching the frame in which the image block is created with the extracted previous frame. In step S217 the controller 150 may be configured to create candidate blocks.

Accordingly, when it rains heavily, rain streaks may be detected at similar positions of image data over several frames. Accordingly, the controller 150 may be configured to create blocks in the previous frames at substantially similar positions to positions where image blocks are created. The controller 150 may be configured to determine the ranks of the candidate blocks such that a block having a smaller sum of difference (SAD) with the image block may have a higher rank Since an optimal motion vector derived using block matching and an optimal block that corresponds thereto may not provide sufficient amount of available information, the image data may not be accurately restored. Therefore, the controller 150 may be configured to determine several candidate blocks. In step S219, the controller 150 may be configured to detect a similarity between the image block and candidate blocks. Specifically, the controller 150 may be configured to separate reliable blocks from unreliable blocks among the candidate blocks using Equation 1 below:

$$Similarity = \frac{{SAD}_{i} - {SAD}_{m i n}}{{SAD}_{ma x} - {SAD}_{m in} - ɛ} \qquad Equation 1$$

wherein SAD_{—max} denotes the maximum value of SAD, SAD_{—min} denotes the minimum value of the SAD, SAD_{—i} denotes a SAD value between the i^{th} candidate block and the image block, and ε denotes a value to determine a candidate block having a SAD value equal to the average value. The similarity may have a lower value when SAD values of candidate blocks are distributed in a narrower range or are distributed in a dominant range in the whole distribution, while it may have a higher value when SAD values of candidate blocks are distributed in a wider range or are not distributed in a dominant range in the whole distribution. When the similarity of candidate blocks thus calculated is below a threshold value, the block may be determined as a reliable candidate block, and otherwise, the block may be determined as an unreliable candidate block.

In step S221, the controller 150 may be configured to use the candidate blocks determined as reliable candidate blocks to restore image data of the area where the removed rain streak was in the image block. The controller 150 may be configured to calculate weights of candidate blocks to restore data of pixels from which rains streaks are removed so that they have brightness that corresponds to weights. Accordingly, the controller 150 may be configured to use Equations 2 and 3 below:

$$R ( j ) = 1 - \frac{The number of rain pixel in block}{The Number of pixel in block} \qquad Equation 2$$

wherein R(j) denotes a ratio of rain pixels in candidate blocks.

$$w ( i , j ) = \frac{1}{z ( i )} R ( j ) {e}^{- \frac{{SAD}_{i}}{{h}^{2}}} \qquad Equation 3$$

wherein w(i, j) denotes weight, Z(i) denotes a leveling condition, and h denotes a variable corresponding to deviation in exponential function. Weight according to similarity may be adjusted by adjusting the variable h.

Subsequently, in step S23, the controller 150 may be configured to output the restored image data on the display 120. By doing so, a driver may see image data from which rain streaks are removed to be provided with a clear view in the event of rain, and accordingly the rate of accidents caused due to unclear views may be reduced.

As set forth above, according to exemplary embodiments of the present invention, in the event of rain, a rain drop may be detected and removed in image data acquired by an imaging device, and image data of a pixel where a rain drop is detected may be restored to be output, to improve the quality of image data and reduce the risk of an accident. Thus far, the image processing apparatus and an image processing method for removing rain streaks from an image data according to the exemplary embodiments have been described. Although the detailed description and the accompanying drawings have been described with respect to the exemplary embodiments and specific terms have been used, these are merely used for the purpose of easily describing the present invention but not used for limiting the scope of the present invention. It is obvious to those skilled in the art that various modifications may be made without departing from the scope of the present invention, other than the exemplary embodiments described herein.

What is claimed is:

1. An image processing apparatus for removing rain streaks from image data, the image processing apparatus comprising:
a memory configured to store program instructions; and
a processor configured to execute the program instructions, the program instructions when executed configured to:
operate an imaging device to acquire image data;
detect and remove a rain streak in the image data; and
restore image data at an area when the removed rain streak was to be output.

2. The image processing apparatus according to claim 1, wherein the program instructions when executed are further configured to detect a brightness of a pixel in the image data and detect a brightness of pixels neighboring the pixel.

3. The image processing apparatus according to claim 2, wherein the program instructions when executed are further configured to select a brightest pixel as a candidate area for the rain streak from among the detected pixels and connect pixels selected as candidate areas for the rain streak to create a single rain streak.

4. The image processing apparatus according to claim 3, wherein the program instructions when executed are further configured to measure an angle and a length of the single rain streak to select final candidate areas for the rain streak and expand a rain streak area into pixels around the final candidate area for the rain streak.

5. The image processing apparatus according to claim 4, wherein the program instructions when executed are further configured to delete data of pixels that correspond to the rain streak area.

6. The image processing apparatus according to claim 5, wherein the program instructions when executed are further configured to create an image block with respect to pixels from which the data is removed and extract at least one previous frame to a current frame to extract a candidate block from the previous frame.

7. The image processing apparatus according to claim 6, wherein the program instructions when executed are further configured to detect a similarity between the image block and the candidate block to restore the pixels from which data is removed with the candidate block.

8. The image processing apparatus according to claim 1, wherein the program instructions when executed are further configured to automatically operate a wiper of a vehicle when the rain streak is detected in the image data.

9. The image processing apparatus according to claim 1, wherein the program instructions when executed are further configured to automatically turn on a lamp including a headlight and a taillight of a vehicle when the rain streak is detected in the image data.

10. The image processing apparatus according to claim 1, further comprising:
a sensor configured to sense a rainfall condition extraneous to a vehicle.

11. An image processing method for removing a rain streak in image data, the image processing method comprising:
acquiring, by a controller, image data;
detecting, by the controller, the rain streak in the acquired image data;
removing, by the controller, the detected rain streak from the image data;
restoring, by the controller, image data at an area where the removed rain streak was; and
outputting, by the controller, the restored image data.

12. The image processing method according to claim 11, wherein the detection of the rain streak includes:
detecting, by the controller, a brightness of a pixel in the image data;
detecting, by the controller, a brightness of pixels neighboring the pixel;
selecting, by the controller, a brightest pixel as a candidate area for the rain streak;
connecting, by the controller, pixels selected as candidate areas for the rain streak to create a single rain streak;
measuring, by the controller, an angle and a length of the single rain streak; and
setting, by the controller, final candidate areas for the rain streak to expand a rain streak area into pixels around the final candidate area for a rain streak.

13. The image processing method according to claim 12, wherein the removal of the detected rain streak includes deleting, by the controller, data of pixel that corresponds to the rain streak area.

14. The image processing method according to claim 13, wherein the restoration of the image data includes:
creating, by the controller, an image block with respect to the pixel from which data is removed;
extracting, by the controller, at least one previous frame to a current frame;
extracting, by the controller, a candidate block from the previous frame; and
detecting, by the controller, a similarity between the image block and the candidate block so as to restore the pixel from which data is removed with the candidate block.

15. A non-transitory computer readable medium containing program instructions executed by a controller, the computer readable medium comprising:
program instructions that acquire image data;
program instructions that detect a rain streak in the acquired image data;
program instructions that remove the detected rain streak from the image data;
program instructions that restore image data at an area where the removed rain streak was; and
program instructions that output the restored image data.

16. The non-transitory computer readable medium of claim 15, wherein the detection of the rain streak further includes:
program instructions that detect a brightness of a pixel in the image data;
program instructions that detect a brightness of pixels neighboring the pixel;
program instructions that select a brightest pixel as a candidate area for the rain streak;
program instructions that connect pixels selected as candidate areas for the rain streak to create a single rain streak;
program instructions that measure an angle and a length of the single rain streak; and
program instructions that set final candidate areas for the rain streak to expand a rain streak area into pixels around the final candidate area for a rain streak.

17. The non-transitory computer readable medium of claim 16, wherein the removal of the detected rain streak includes program instructions that delete data of pixel that corresponds to the rain streak area.

18. The non-transitory computer readable medium of claim 17, wherein the restoration of the image data includes:
program instructions that create an image block with respect to the pixel from which data is removed;
program instructions that extract at least one previous frame to a current frame;
program instructions that extract a candidate block from the previous frame; and
program instructions that detect a similarity between the image block and the candidate block so as to restore the pixel from which data is removed with the candidate block.
